(19) United States
(12) Patent Application Publication
(10) Pub. No.: US 2022/0226945 A1
(43) Pub. Date: Jul. 21, 2022

(54) METHOD FOR PRODUCING A CUTTING TOOL WITH A RECESS

(71) Applicant: Guehring KG, Albstadt (DE)

(72) Inventor: Jochen GRUBER, Inzigkofen (DE)

(73) Assignee: Guehring KG, Albstadt (DE)

(21) Appl. No.: 17/655,027

(22) Filed: Mar. 16, 2022

Related U.S. Application Data
(63) Continuation of application No. PCT/DE2020/100902, filed on Oct. 20, 2020.

(30) Foreign Application Priority Data
Oct. 25, 2019 (DE) 10 2019 128 929.7
Jun. 30, 2020 (DE) 10 2020 117 141.2

(51) Int. Cl. B23P 15/28; B23B 27/16

(52) U.S. Cl. CPC B23P 15/28; B23B 27/1611

(57) ABSTRACT

The invention relates to a method for producing a cutting tool comprising the following steps: a) providing a starting material for use in an additive manufacturing method in a plurality of material layers; and b) bonding each material layer of the starting material in the form of an indexable insert, wherein the material layers are arranged such that a recess is formed in the cutting tool for securing the cutting tool with a fastener to a tool base body in order to secure the cutting tool with a tool reference level that is parallel to a support plane of a tool base body.

The invention relates to a method for producing a cutting tool with a recess and a cutting tool according to the respective independent claim.

The invention relates the technical field of indexable inserts. Indexable inserts serve the purpose of cutting metals or wood, for example.

Indexable inserts can be fastened in a tool holder, such as, e.g., a milling tool. Indexable inserts are available in various shapes and sizes, in order to be capable of being used in an application-specific manner. For example in the case of a milling tool, the milling head, to which the indexable inserts are firmly attached, is set into rotation for machining, and the rotating cutting edge is brought into contact with the workpiece to be treated.

The advantage with the use of indexable inserts comprising several blades is that the cutting insert can be rotated or turned and a new blade can thus be put to use as soon as a cutting edge wears and has become unusable, after releasing a clamping device. The rotated indexable insert can be used again repeatedly. Indexable inserts often have three or four blades, so that it can be rotated twice or three times, respectively, before it is replaced.

Due to the large variety of possible uses and the specific requirements on the geometry associated therewith, there is a need for a plurality of different indexable inserts. This is problematic in particular with regard to the storage of replacement parts because a corresponding plurality of different indexable inserts has to be kept ready, in order to provide them quickly on the market.

The invention has thus taken on the object of providing a method for producing an indexable insert with a recess and an indexable insert made of a material for the sinter-based and/or melt-based additive manufacture, which overcome the disadvantages in the prior art and which in particular ensure a quick provision of a wide variety of indexable inserts as replacement parts in an economically advantageous manner.

This object is solved by means of a method for producing a cutting tool with a recess and an indexable insert made of a material for the sinter-based and/or melt-based additive manufacture according to the respective independent claim. The subject matter of the dependent claims relates to advantageous designs.

The invention comprises a method for producing a cutting tool with a recess, comprising the following steps:
a) providing a starting material for use in an additive manufacturing method in several layers of material; and
b) bonding each layer of material of the starting material in the form of a cutting tool.

The layers of material are thereby arranged in such a way that an (inner) recess, (which is enclosed on all sides and which tapers at least in some sections) in the indexable insert in order to fasten the cutting tool to a tool base body by means of a fastening means is created, in order to fasten the cutting tool with a tool reference plane parallel to a support plane of a tool base body.

The cutting tool is preferably an indexable insert.

In at least one first sectional plane parallel to the tool reference plane and a second sectional plane parallel to the tool reference plane, the recess is advantageously formed with differing cross sectional contours.

In at least one sectional plane parallel to the tool reference plane, the recess is advantageously not formed in a radially symmetrical manner.

In at least one sectional plane parallel to the tool reference plane, the cross sectional contour of the recess is further preferably formed with a corner.

The recess is particularly preferably formed at an angle α<90° to the tool reference plane.

The recess is preferably formed with a recess section, which, corresponding to a bottom side of a panhead screw, is formed with flat bottom side, or of a countersunk head screw with conical bottom side, or of a raised countersunk head screw, or of a washer head screw, in order to at least partially receive the screw head.

A surface post-treatment preferably does not take place at the recess.

A polishing and/or grinding further preferably does not take place at the recess.

Particularly preferably, a wavy surface is created.

A surface with channel-like recesses is further preferably created.

According to an advantageous aspect, the provision of the starting material for use in the additive manufacturing method in several layers of material comprises the provision of powdery or molten starting material. The powdery material can be solidified in a separate step. The molten starting material can be bonded solely by means of cool-down.

The provision of the starting material for use in the additive manufacturing method in several layers of material further preferably comprises the provision of starting material from a group of hard metal, solid carbide, polycrystalline cubic boron nitride (CBN), polycrystalline diamond (PCD), or combinations thereof.

The starting material is advantageously bonded in several layers of material in the form of an indexable insert in a for use in a sinter-based and/or melt-based additive manufacturing method. The layers of material can thereby have an identical or different form. In particular the following may be considered as additive manufacturing methods: laser sintering (SLS), stereolithography (SLA), polygraphy, fused deposition modeling (FDM), selective laser melting (SLM), and 3D printing (3DP). These methods are generally suitable to apply the advantages of the additive manufacture in the area of the indexable inserts.

The provision of a starting material for use in an additive manufacturing method further advantageously takes place in several layers of material.

According to an advantageous aspect, the layers of material are arranged in such a way that a recess is created in the indexable insert in order to fasten the indexable insert to a tool base body by means of a fastening means, in order to fasten the indexable insert with a tool reference plane parallel to a support plane of a tool base body. The fastening means can thereby be a screw.

In addition to a further advantageous aspect, the recess comprises differing cross sectional contours in at least one first sectional plane parallel to the tool reference plane and a second sectional plane parallel to the tool reference plane. The recess can thereby be formed in such a way, so that the cross sectional contours of the first sectional plane and of the second sectional plane have different diameters.

According to a particularly advantageous aspect, the recess is not radially symmetrically in at least one sectional plane parallel to the tool reference plane.

According to a preferred aspect, in at least one sectional plane parallel to the tool reference plane, the cross sectional contour of the recess has a corner. Recesses of this type cannot be created by means of bores.

According to a further preferred aspect, the recess is formed at an angle α<90° to the tool reference plane.

According to a particularly preferred aspect, the recess comprises a recess section, which, corresponding to a bottom side of a panhead screw, is formed with flat bottom side, or of a countersunk head screw with conical bottom side, or of a raised countersunk head screw, or of a washer head screw, in order to at least partially receive the screw head.

According to a further advantageous aspect, a surface post-treatment does not take place at the recess.

According to a particularly advantageous aspect, a polishing and/or grinding does not take place at the recess. The roughness of the surface is thus obtained after the production process in order to be able to optimally arrange the fastening means, for example a screw, in the recess.

The invention will be described below on the basis of the example illustrated in the drawings, in which:

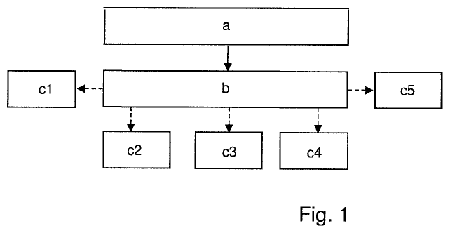

FIG. 1 shows a block diagram for a method for producing an indexable insert according to an exemplary embodiment of the invention;

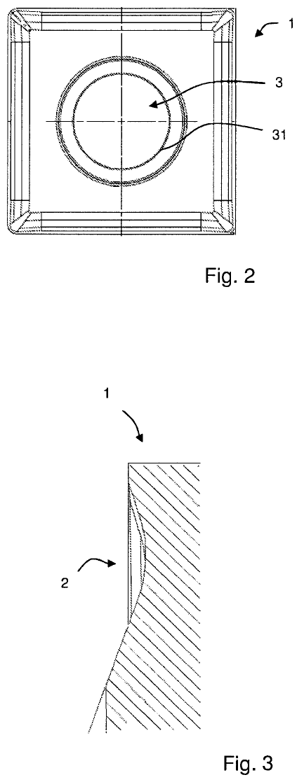

FIG. 2 shows a top view onto an indexable insert with a recess according to an exemplary embodiment of the invention;

FIG. 3 shows a sectional view onto the indexable insert from FIG. 2; and

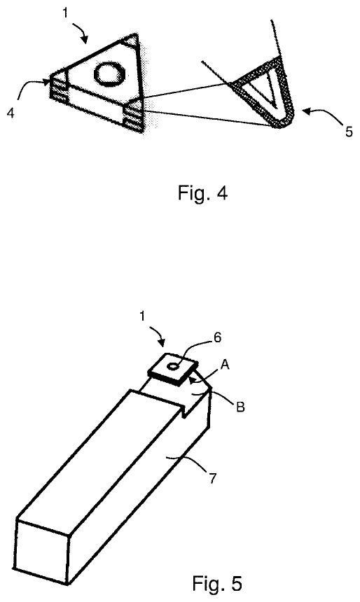

FIG. 4 shows a sectional view onto an indexable insert with triangular recess and cutting elements arranged therein.

FIG. 5 shows a schematic view onto an indexable insert with recess on a tool base body.

A method for producing an indexable insert 1 with a recess is illustrated in an exemplary manner in FIG. 1.

In the method according to the invention, the starting material is provided during a sinter-based and/or melt-based additive manufacture to form an indexable insert 1, so that a large variety of indexable inserts b1 can be provided in an economically advantageous manner.

In the first step, a starting material is provided thereby for use in an additive manufacturing method in several layers of material. (step a).

The layers of material will advantageously be arranged in such a way that a recess (see FIG. 2, reference numeral 3) is created in the indexable insert 1 in order to fasten the indexable insert 1 to a tool base body by means of a fastening means, in order to fasten the indexable insert 1 with a tool reference plane parallel to a support plane of a tool base body.

In this example, the recess 3 is formed with differing cross sectional contours in at least one first sectional plane parallel to the tool reference plane and a second sectional plane parallel to the tool reference plane.

In at least one sectional plane parallel to the tool reference plane, the recess advantageously is not formed in a radially symmetrical manner.

In at least one sectional plane parallel to the tool reference plane, the cross sectional contour of the recess is further preferably formed with a corner.

The recess is particularly preferably formed at an angle α<90° to the tool reference plane.

The recess is preferably formed with a recess section, which, corresponding to a bottom side of a panhead screw, is formed with flat bottom side, or of a countersunk head screw with conical bottom side, or of a raised countersunk head screw, or of a washer head screw, in order to at least partially receive the screw head.

A surface post-treatment preferably does not take place at the recess.

A polishing and/or grinding further preferably does not take place at the recess.

In alternatives, the starting material can be provided in a powdery or molten manner in this step (step a). It is also possible to provide the starting material in a carrier material. The starting material can be from a group of hard metal, solid carbide, polycrystalline cubic boron nitride (CBN), polycrystalline diamond (PCD), or combinations thereof.

For example, each layer of material of the starting material can be provided in the form of an indexable insert, or at least two layers of material in a different form.

Moreover, at least two different starting materials can be provided.

A bonding of each layer of material of the starting material in the form of an indexable insert takes place in the subsequent step (step b).

In an alternative, the layer of material of the starting material is heated up by a predetermined temperature, in order to solidify the starting material.

In a further alternative, an adhesive is used to bond each layer of material of the starting material.

It is possible thereby that after the provision of the starting material in several layers of material, method step b) is performed after a respective provided layer of material. This can be repeated multiple times.

In one alternative, it is provided that the method further comprises the method step of grinding of the indexable insert. (step c1)

In one alternative, it is provided that the method further comprises the method step of edge rounding of the indexable insert. (step c2)

In one alternative, it is provided that the method further comprises the method step of abrasive blasting of the edges of the indexable insert. (step c3)

In one alternative, it is provided that the method further comprises the method step of heat treatment of the indexable insert. (step c4)

In a further alternative, it is provided that the method further comprises the method step of coating of the indexable insert with a hard substance, in particular with a tribological hard substance. (step c5)

An exemplary embodiment of an indexable insert 1 is shown in a top view in FIG. 2. Along the outer contour, the indexable insert 1 comprises a chip guiding groove 2, along which a removed chip is guided and broken. The chip guiding groove 2 is formed in a curved or concave manner, respectively, for this purpose.

Without being limited to the alternative with the chip guiding groove, the design of the cross sectional contour 31 of the recess 3 likewise becomes clear in FIG. 2.

A sectional view of the indexable cutting plate 1 from FIG. 2 is illustrated in FIG. 3. According to an advantageous example, the curvature of the chip guiding groove 2 along the side wall is formed here over the entire side surface of the indexable insert 1.

A further example for an indexable insert 1 comprising contour section 5 on the top side in the manner of a chip breaker is shown in FIG. 4. A top side thereby comprises a circumferential elevated contour section 5, the middle of which is lowered, in order to guide the resulting chip in the manner of a wave breaker, and to break it thereby.

In the shown example, the indexable insert 1 in each case comprises a triangular recess 4 on each corner and on top side and bottom side. Triangular cutting elements (PCD, CBN) are to be received so as to be arranged in the recess 4. According to the method, it can be provided thereby that the indexable inserts are soldered in separately or are formed in the additive production process in a corresponding method step.

FIG. 5 shows a schematic view of an indexable insert 1 with recess 6 on a tool base body 7.

The recess 6 in the indexable insert 1 serves the purpose of fastening the indexable insert 1 to the tool base body 7 by means of a fastening means, for example a screw.

The indexable insert 1 is thereby fastened with a tool reference plane A parallel to the support plane B of the tool base body 7.

1. A method for producing a cutting tool, comprising:
a) providing a starting material for use in an additive manufacturing method in several layers of material; and
b) bonding each layer of material of the starting material in the form of an indexable insert, wherein the layers of material are arranged in such a way that a recess is created in the cutting tool in order to fasten the cutting tool to a tool base body by means of a fastening means, in order to fasten the cutting tool with a tool reference plane parallel to a support plane of the tool base body.

2. The method according to claim 1, wherein the cutting tool is an indexable insert.

3. The method according to claim 1, wherein in at least one first sectional plane parallel to the tool reference plane and a second sectional plane parallel to the tool reference plane, the recess comprises differing cross-sectional contours.

4. The method according to claim 2, wherein the recess is not radially symmetrical in at least one sectional plane parallel to the tool reference plane.

5. The method according to claim 3, wherein in at least one sectional plane parallel to the tool reference plane, the cross-sectional contour of the recess has a corner.

6. The method according to claim 1, wherein the recess is formed at an angle <90° to the tool reference plane.

7. The method according to claim 1, wherein the recess comprises a recess section, which, corresponding to a bottom side of a panhead screw, is formed with a flat bottom side, or of a countersunk head screw with a conical bottom side, or of a raised countersunk head screw, or of a washer head screw, in order to at least partially receive a screw head.

8. The method according to claim 1, wherein a surface post-treatment does not take place at the recess.

9. The method according to claim 8, wherein a polishing and/or grinding does not take place at the recess.

10. The method according to claim 1, wherein a wavy surface is created.

11. The method according to claim 1, wherein a surface with channel-like recesses is created.

12. The method according to claim 1, wherein said providing a starting material for use in an additive manufacturing method in several layers of material comprises providing powdery or molten starting material.

13. The method according to claim 1, wherein said providing a starting material for use in an additive manufacturing method in several layers of material comprises providing the starting material from a group of hard metal, solid carbide, polycrystalline cubic boron nitride (CBN), polycrystalline diamond (PCD), or combinations thereof.

14. The method according to claim 1, wherein the starting material is bonded in several layers of material in the form of an indexable insert for use in a sinter-based and/or melt-based additive manufacturing method.

15. The method according to claim 1, wherein said providing a starting material for use in an additive manufacturing method takes place in several of said layers of material.

16. An indexable insert produced by a method according to claim 1.

17. A tool comprising an indexable insert according to claim 16.
